(19) United States
(12) Patent Application Publication
(10) Pub. No.: US 2010/0053984 A1
(43) Pub. Date: Mar. 4, 2010

(54) Illuminated handle bar grip

(76) Inventor: Weng-Shih Wang, Taipei (TW)

Correspondence Address: SALLY CHANG, 7F, NO. 3, ALLEY 32, SEC. 6 CHUNG-HSIAO EAST RD., TAIPEI, TAIWAN, R.O.C. 115, TAIPEI, 115, TW

(21) Appl. No.: 12/230,573

(22) Filed: Sep. 2, 2008

(51) Int. Cl. B62J 6/00

(52) U.S. Cl. 362/474

(57) ABSTRACT

An illuminated handlebar grip (1) can be lit up thoroughly to improve two-wheeled vehicle safety comprising: a grip (12) accommodates a handlebar (9) received therein; a battery seat (2) is disposed inside the container (121) which is formed in the second close end of the grip (12), and is covered up by a cover (11) coupled to a second end of said grip (12); said battery seat (2) is extended inside the grip (12) to form a cylindrical battery chamber (21) for receiving batteries (6); a light emitting device (3) installed in the battery seat (2); and a positioning cover (4) provided between the cover (11) and PCB (31) to prevent any displacement of the PCB (31).

### FIELD OF THE INVENTION

The present invention is related to an illuminated handle bar grip, particularly for two-wheeled vehicle such as bicycle, motorcycle or scooter.

### DESCRIPTION OF PRIOR ART

Two wheeled vehicle includes bicycle, motorcycle, or scooter, being driven at night, or making tight turns, may give off light to signify warning signs to the coming cars or following cars or pedestrians. Persons skilled in the art have provided light emissions from handle bar grip to increase the visibility of cyclists or motorcyclists or the like.

Such as U.S. Pat. No. 6,308,590 entitled “Handle bar device” to Joseph Berto on Oct. 30, 2001 (hereinafter '590), it disclosed an enlarged end of the handle bar has a perimeter greater than the handlebar grip without the rider's hand slipping off the end of the grip and with less fatigue. An illumination element provides additional lighting to the vehicle for greater safety for the rider. A conical frustum camming element has protrusions to fit into slots of a longitudinally extending member to prevent the camming element from rotating, or a cylindrical member expands to contact the internal surface of the handlebar. As above, the camming element can be anchored inside the handlebar by friction fit. The illumination element located within the enlarged end is in electrical communication with the lighting system of the vehicle. The enlarged end comprises a removable cover which attaches to a base either by press fit or threadingly. An annular surface of the cover fits snugly or threadingly into the recess in the base. The removable cover allows access to the illumination element and a fastener.

Or US published 20070221644 entitled “Internal handlebar heater” to Gifford et al., on Sep. 27, 2007 (hereinafter '644), it disclosed that a spring clip is capable of being compressed radially to a size to fit coaxially in an open end of the handlebar and upon release of the compression, the spring clip expands radially to provide substantial contact of the spring clip with the handlebar. The spring clip may optionally be secured to the heating element, which is fit coaxially into the open end of the handlebar and shaped to provide substantial contact with the handlebar. This internal heater along with the associated electronic controller, with the heat level selection switch and LED indicators, will offer the easiest to install and safest grip heater.

In '590, only the illumination element exposed on the enlarged end can be illuminated, while such as the camming element inside the handlebar grip will not emit light therefrom. Thus, only light emission to the enlarged end may be seen. Accordingly, how can we expand the area on the handlebar grip for light emission to promote the warning effect is expected in the present invention.

However, in '644, the heating element secured by the spring clip, though, is designed easy in installation. While the heating element is hidden from view inside the handlebar, even LED indicators are increased to ensure an easy installation of the grip heater, but visibility of the riders are not emphasized by such a heater and LED indicators.

Installation of either the enlarged end with illumination element or the hidden heater with LED indicators is not so easy to increase the visibility of the rider. Since the enlarged end is substantially designed to lengthen and enlarge the handlebar, thus the increased illumination element is so easy to be damaged by impacts exerted from outer forces, while the LED indicators in response to the heater, and light emission of such LEDs is not sufficient to signify warning signs.

Under such circumstances, an illuminated handlebar for safety of the invention must meet the requirements as follows: to expand the illumination area, easy of installation, to fix, at least, a printed circuit board (PCB) to the handlebar with stable configuration, and water vapor will not permeate through the handlebar to the illumination element for improving such a device.

### SUMMARY OF THE INVENTION

The present invention is to provide an illuminated handlebar for safety when riding two-wheeled vehicles, such as bicycle, motorcycle, and scooter. The illuminated handlebar for safety can be realized by two embodiments. A first embodiment of the illuminated handlebar for safety includes:

An illuminated handlebar grip (1) comprises a grip (12) pervious to light, a first open end of the grip (12) accommodates a handlebar (9) received therein, a second closed end of the grip (1) is formed with a container (121); a battery seat (2) pervious to light disposed inside the container (121), a second end of said battery seat (2) is extended inside the grip (12) to form a cylindrical battery chamber (21) for receiving batteries (6); an outside diameter of said battery chamber (21) is smaller than an inside diameter of said handlebar (9); and a light emitting device (3) installed inside the battery seat (2), said batteries (6) supply power to the light emitting device (3), which is composed of a printed circuit board (PCB) (31), a switch (32) disposed on the PCB to electrify the PCB, a plurality of light emitting diodes (LEDs) (33, 34) are disposed on both first and second sides of the PCB (31) relatively, an integral circuit (IC) activates LEDs (33, 34) to light; and a cover (11) pervious to light is coupled to a second end of said grip (12) facing outward; the cover (11) can cover up said container (121).

A second embodiment of the illuminated handlebar for safety includes:

An illuminated handlebar grip (1) comprises a grip (12) pervious to light, a first open end of the grip (12) accommodates a handlebar (9) received therein, a second closed end of the grip (1) is formed with a container (121); and a light emitting device (3) installed inside the container (121); the light emitting device (3) is composed of a printed circuit board (PCB) (31), a switch (32) disposed on the PCB to electrify the PCB, a plurality of light emitting diodes (LEDs) (33, 34) are disposed on both first and second sides of the PCB (31) relatively, and an integral circuit (IC) activates LEDs (33, 34) to light; said PCB (31) is connected to a power line (37) passed through the grip (12), the power line (37) is further electrically connected to a vehicle battery or an electric switch of turn light; and a cover (11) pervious to light is coupled to a second end of said grip (12) facing outward; the cover (11) can cover up said container (121).

### ADVANTAGES OF THE EMBODIMENTS OF THE INVENTION

The handlebar grip (1) consists of a cover (11) pervious to light and a grip (12) pervious to light. When the light emitting device (3) inside the grip (12) lights up the grip (12), which is sufficient to signify warning signs. It may replace the same to give off light only on the enlarged end of '590.

The handlebar grip (1) is easy to install to both ends of the handlebar of the vehicle. Replacement of batteries is simple also any maintenance is easy to be made.

The handlebar grip (1) can be added with various accessories, such as electro luminescence (EL) (i.e. a conventional double-insulated one in which the luminescence film is sandwiched in between an upper and a lower insulating films by stacking one upon another further electrodes formed as films laminated between different films separately), surface mounted device (SMD) long strip in shape, and solar panel (8), value added to the handlebar grip (1) is significant to adapt to various requirements.

A positioning cover (4) added inside the handlebar grip (1) can push the PCB in position, further a tenon (24) inside the battery seat (2) is corresponding to a mortise (36) on the PCB (31). Thus the PCB can be inlaid in the battery seat (2) securely. Said cover (11) is watertight to prevent water vapor from permeating into the container (121).

### BRIEF DESCRIPTION OF DRAWINGS

FIG. 1: is an assembled view of the grip of the present invention.

FIG. 2: is an exploded view of FIG. 1.

FIG. 3: is a cross section view of the grip coupled to a handlebar taken on line III-III of FIG. 1.

FIG. 4: is a wiring diagram of the present invention.

FIG. 5: is a schematic view of the grip coupled to a motorcycle handlebar.

FIG. 6: is an enlarged view of the illuminated handlebar grip of FIG. 5.

FIG. 7: is a schematic view of the grip coupled to a bicycle handlebar.

FIG. 8: is an enlarged view of the illuminated handlebar grip of FIG. 7.

FIG. 9: is a schematic view showing the EL inside the grip.

FIG. 10: is an exploded view of FIG. 9.

FIG. 11: is a schematic view showing the SMDs inside the grip.

FIG. 12: is an exploded view of FIG. 11.

FIG. 13: is a plain view showing the solar panels on the grip.

FIG. 14: is an exploded view of FIG. 13.

FIG. 15: is a cross section view taken on line XV-XV of FIG. 13.

FIG. 16: is a schematic view of the second embodiment of the present invention.

FIG. 17: is an exploded view of FIG. 16.

### DETAIL DESCRIPTION OF THE PREFERRED EMBODIMENT OF THE PRESENT INVENTION

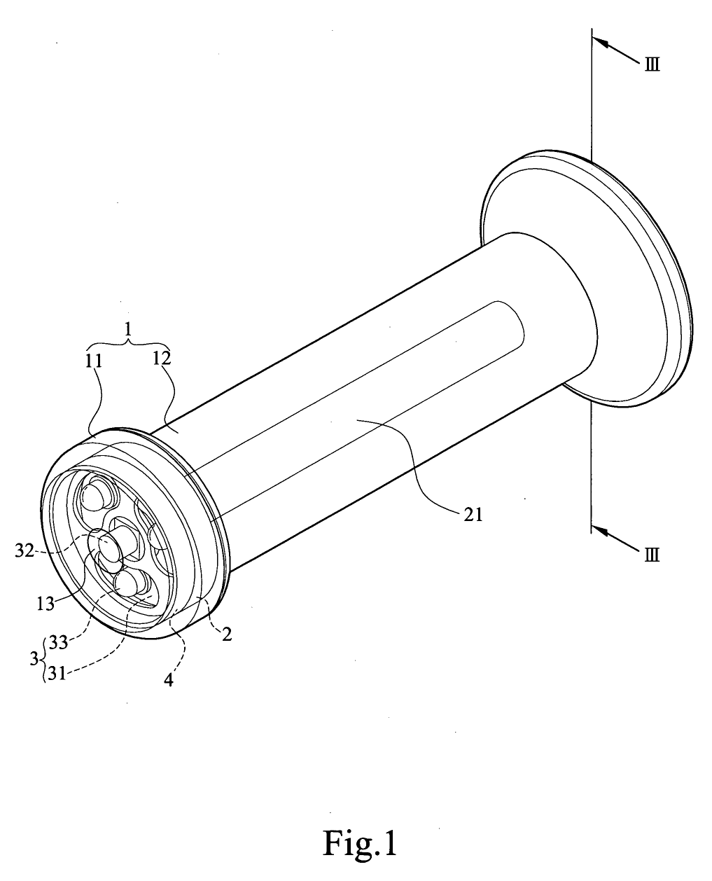

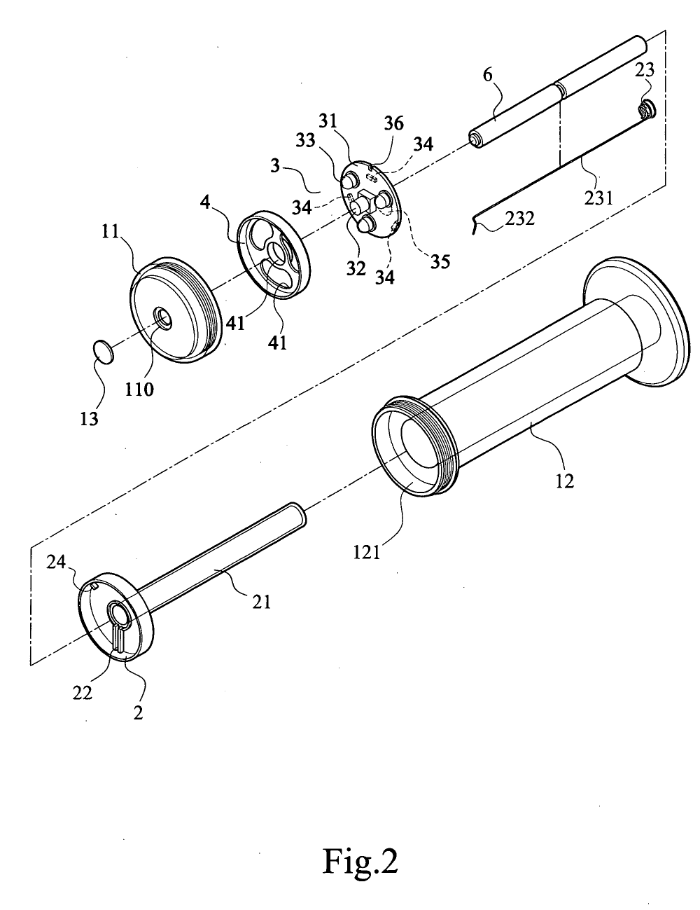

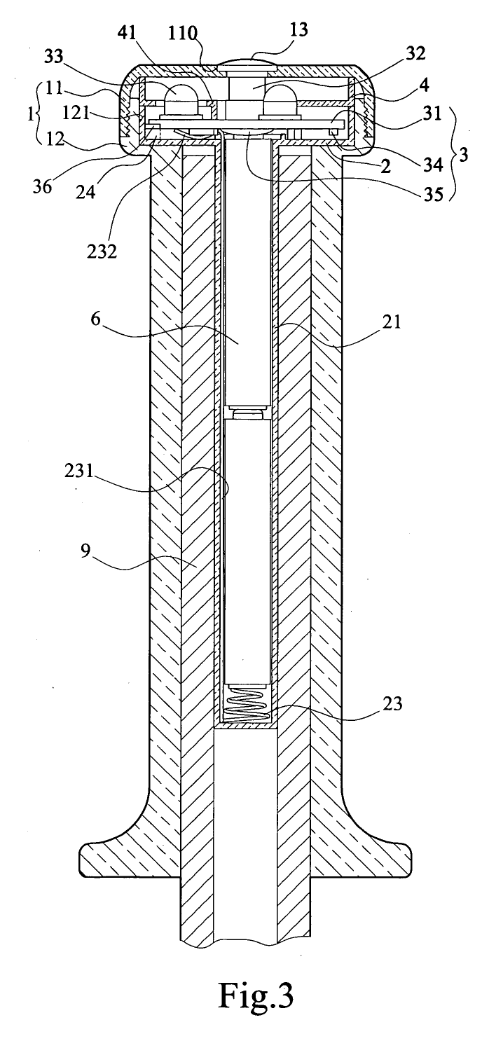

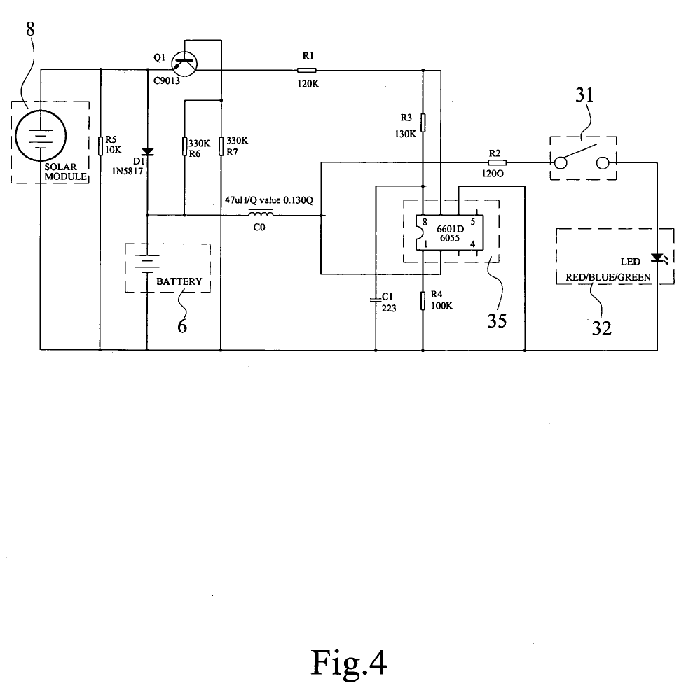

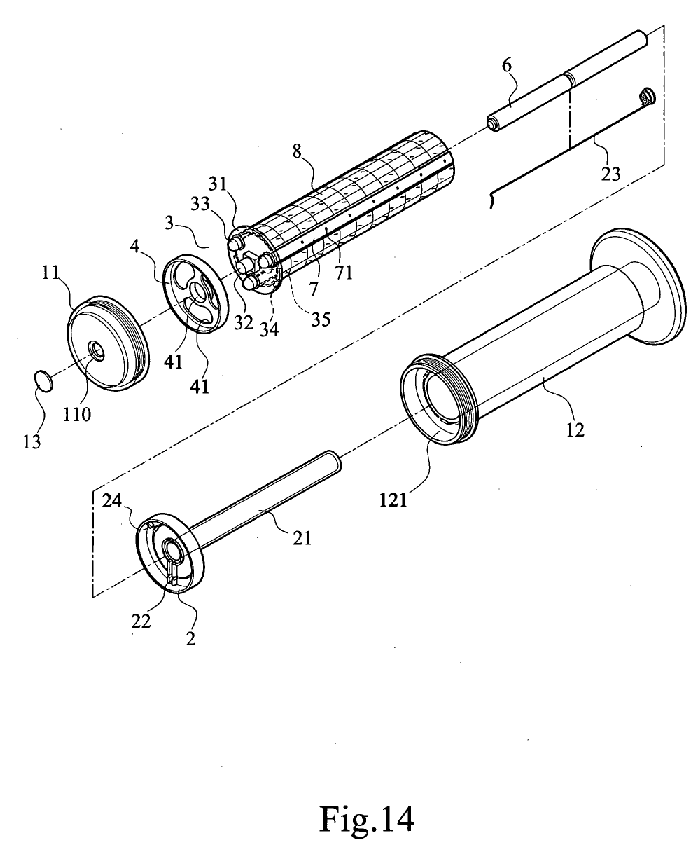

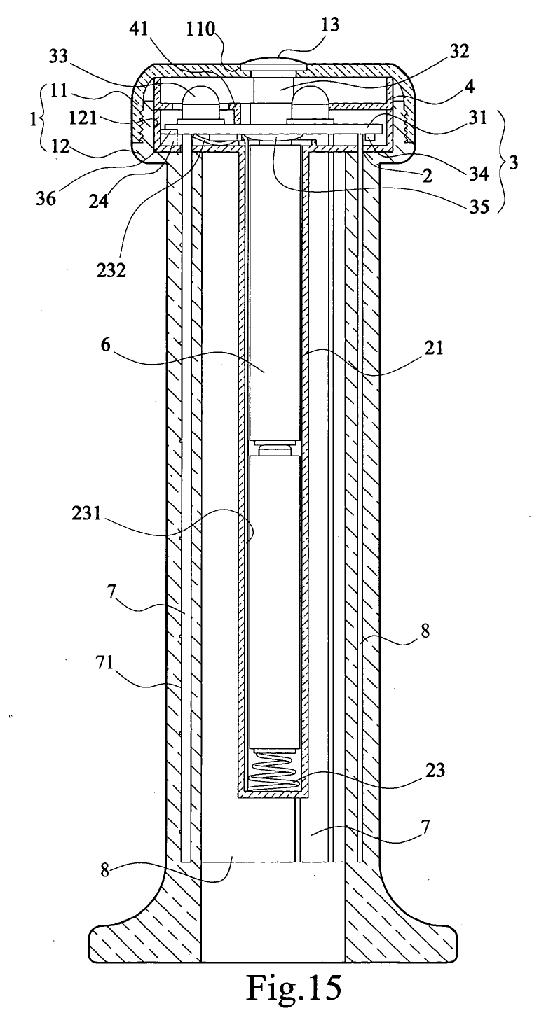

Hereinafter, the description is given of an illuminated handlebar grip according to the invention citing modes of first and second embodiments with reference to accompanying FIGS. 1 to 17.

### First Embodiment

As shown in FIGS. 1˜3, an illuminated handlebar grip (1) comprises a grip (12) pervious to light, a first open end of the grip (12) accommodates a handlebar (9) received therein, a second closed end of the grip (1) is formed with a container (121); a battery seat (2) pervious to light disposed inside the container (121), a second end of said battery seat (2) is extended inside the grip (12) to form a cylindrical battery chamber (21) for receiving batteries (6); an outside diameter of said battery chamber (21) is smaller than an inside diameter of said handlebar (9); and a light emitting device (3) installed inside the battery seat (2), said batteries (6) supply power to the light emitting device (3), which is composed of a printed circuit board (PCB) (31), a switch (32) disposed on the PCB to turn on/off the light emitting device (3), a plurality of light emitting diodes (LEDs) (33, 34) are disposed on both first and second sides of the PCB (31) relatively, and an integral circuit (IC) is programmed with several effects to flash said LEDs (33, 34) in continuous sequence; and a cover (11) pervious to light is coupled to a second end of said grip (12); the cover (11) can cover up said container (121).

Both said first and second sides of the PCB (31) are distributed with said LEDs (33, 34) respectively, light emission of said LEDs (33) is transmitted through the cover (11) to the handlebar grip (1) pervious to light. Light emission of the LEDs (34) is transmitted through the grip (12) to the first end thereof. Thus, the grip (12) incorporated to the handlebar can be lit up integrally.

A positioning cover (4) disposed inside the container (121) covers up said light emitting device (3) to resist against said cover (11). The light emitting device (3) is therefore prevented from displacements by the positioning cover (4). A plurality of holes (41) formed through the positioning cover (4) accommodates a switch (32) and a plurality of LEDs (33) passed therethrough. The light emitting device (3) is therefore further fixed inside the positioning cover (4), even the vehicle coasts on the way or jogs the user up and down, the light emitting device (3) will not displace therefrom. In addition, the inner wall of said container (121) includes tenon (24) to joint the mortise (36) on the edge of the PCB (31), preventing any rotation of said PCB (31).

Said cover (11) has a position hole (110) relative to the switch (32), a flexible water tight plastic cap (13) disposed inside said position hole (110) can be manually pressed by a user. When said cap (13) is pressed by the user, said switch (32) is switched on. LEDs (33, 34) are electrified to emit light. Said cap (13) being pressed again, the switch (32) is switched off. LEDs (33, 34) are dimmed. Said switch (32) is switched on or off alternatively in two stage operation. While being operated with an IC (35), three stage operation of the switch is performed (i.e. first stage light up LEDs constantly, second stage LEDs are lit intermittently, and third stage LEDs are dimmed). Multiple stage operation performance may light up said LEDs in sequence, or said LEDs are lit in color optionally such as first red LEDs are lit, second green, and third blue in turn.

A battery contact leaf spring (23) is disposed to a bottom of the cylindrical battery chamber (21) for said batteries (6). Said leaf spring (23) is extended to the battery seat (2) with a spring wire (231). A second end of said spring wire (231) is bent to form a hook (232) electrically connected to said PCB (31); said hook (232) is inlaid into a positioning groove (22) of the battery seat (2). An anode of said batteries (6) resists against a first side of the PCB (31), and a cathode of said batteries (6) is in contact with the leaf spring (23). Positive electric current is conducted to PCB (31) directly from said batteries (6), negative electric current is conducted to PCB (31) through the spring wire (231) and the hook (232) to electrify said light emitting device (3) mainly on the second side of the PCB (31).

To facilitate the grip (12) easy of installation, or replacement of said batteries (6), or maintenance, said illuminated grip (12) and said cover (11) are made from polyurethane, polyvinyl chloride (PVC) or similar material pervious to light. And, said grip and said cover, though pervious to light and equipped with said light emitting device (3) are designed to fit over said handlebar to be electrified to light up thoroughly. Once said grip (12) is necessary to be replaced or repaired or added with more accessories, said grip (12) is designed as an easily assembled and detached grip.

Said cover (11) and grip (12) may be added with additives (121) such as: phosphor powders, luminescence powders, or glitter splash powders.

Phosphor powders may increase fluorescent light to said light emitting device (3). While said luminescence powders may absorb light in daytime, but emit luminescence light at night, even the light emitting device (3) breaks down, the luminescence powders still has light yield of the total intensities. Said glitter splash powders are colorful with light reflection attract user's attention.

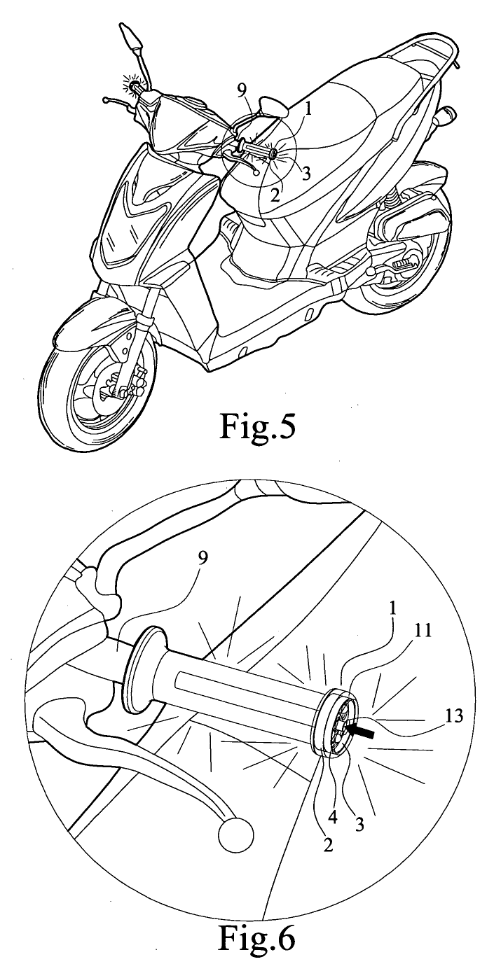

As shown in FIGS. 5 and 6, said illuminated handlebar grip (1) accommodates handlebar (9) of a motorcycle received therein; said battery chamber (21) of said battery seat (2) is led into the handlebar (9). Said battery seat (2), said light emitting device (3) and said cover (11) are disposed to a second end of the handlebar (9) facing outward. Whether the light emitting device (3) is lit up or not is determined by a pressing to a water tight plastic cap (13) on top of said cover (11) by user's manual operation.

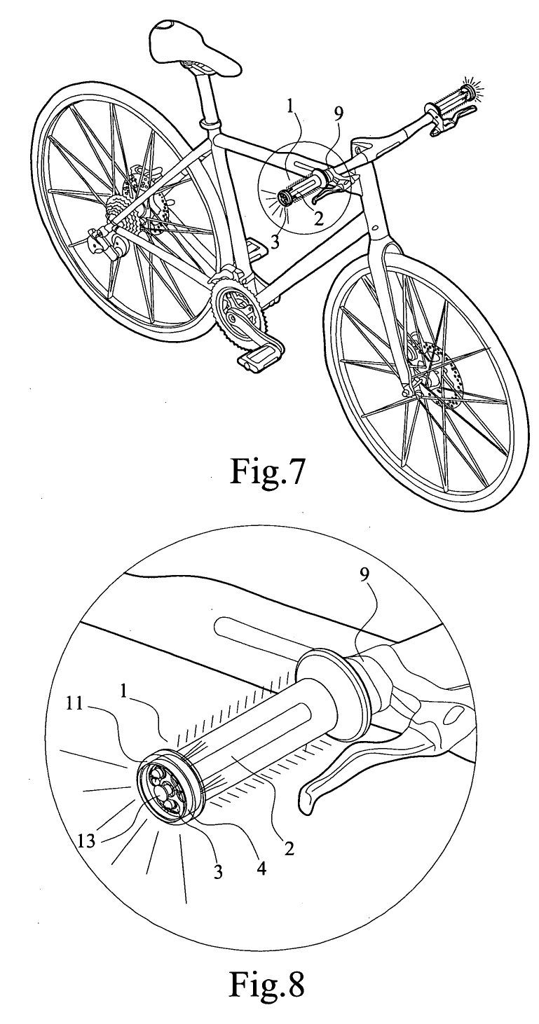

As shown in FIGS. 7 and 8, similar to FIGS. 5-6, said illuminated handlebar grip (1) accommodates handlebar (9) received therein.

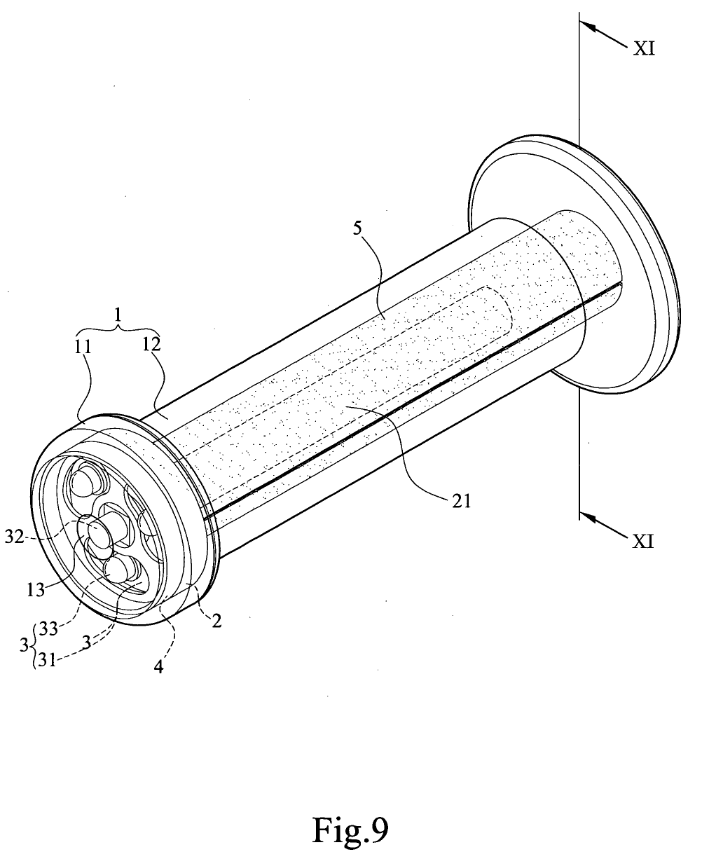

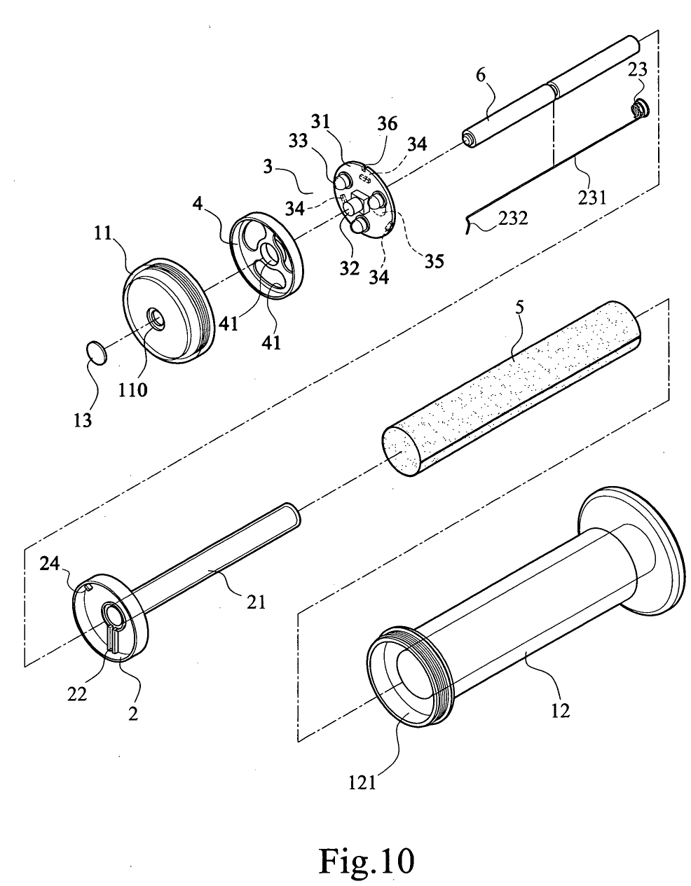

As shown in FIGS. 9 and 10, an electro luminescence (EL) (5) is disposed along an inner wall of said grip (12), or one of the following can be used instead to reduce LEDs installed to the light emitting device with evenly distributed light performance: fluorescent film, luminous film or light guide film, so as to increase light emission to the grip (12).

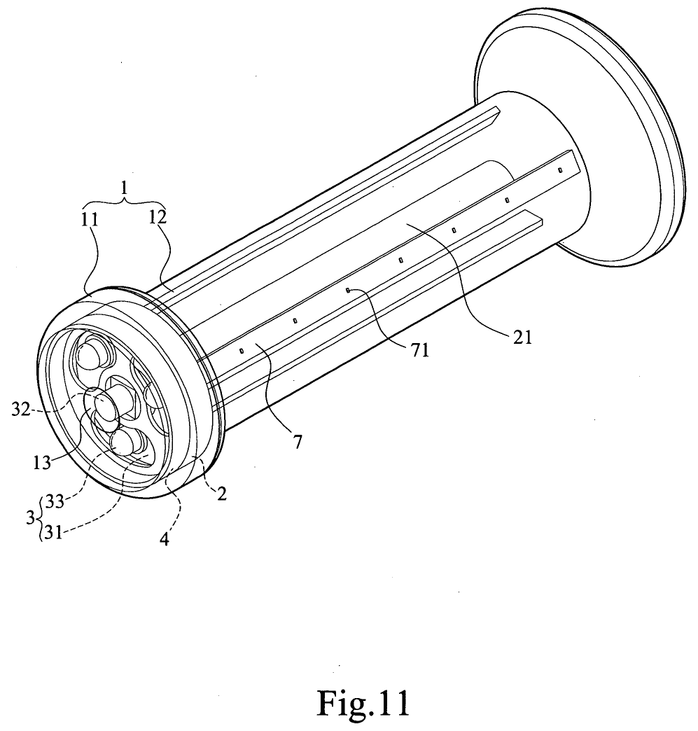

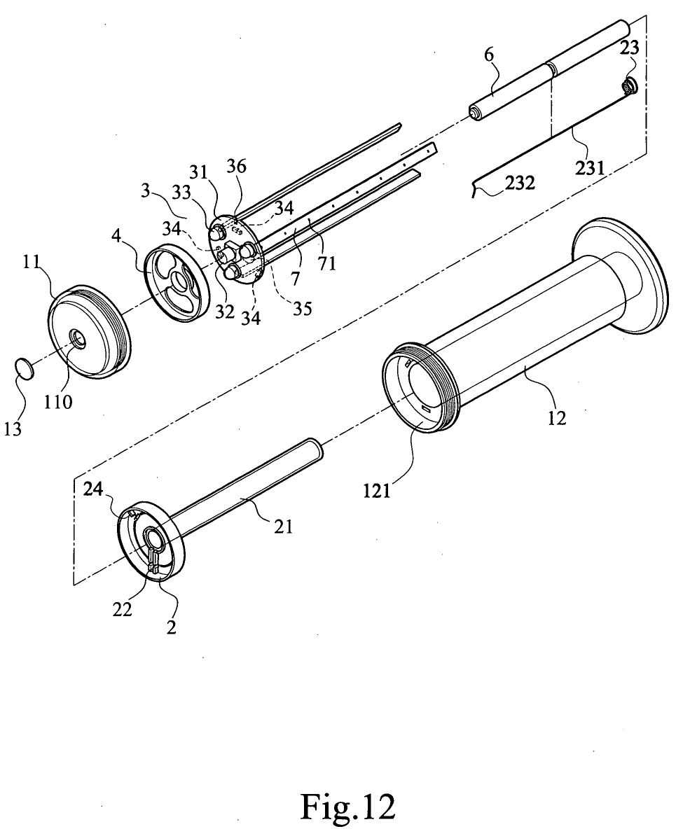

As shown in FIGS. 11 and 12, a plurality of surface mounted devices (SMDs) (7) long strips in shape are electrically insulated from the grip (12) and the handlebar, but said SMDs are led into and disposed along an inner wall of said grip (12). Said SMDs are substantially co-axial disposed inside said grip (12) with a plurality of light emitting diodes (LEDs) (71) facing outward. Second ends of said SMDs are electrically connected to said PCB (31), once said SMDs are electrified to light up said LEDs, said grip (12) is therefore thoroughly lit up.

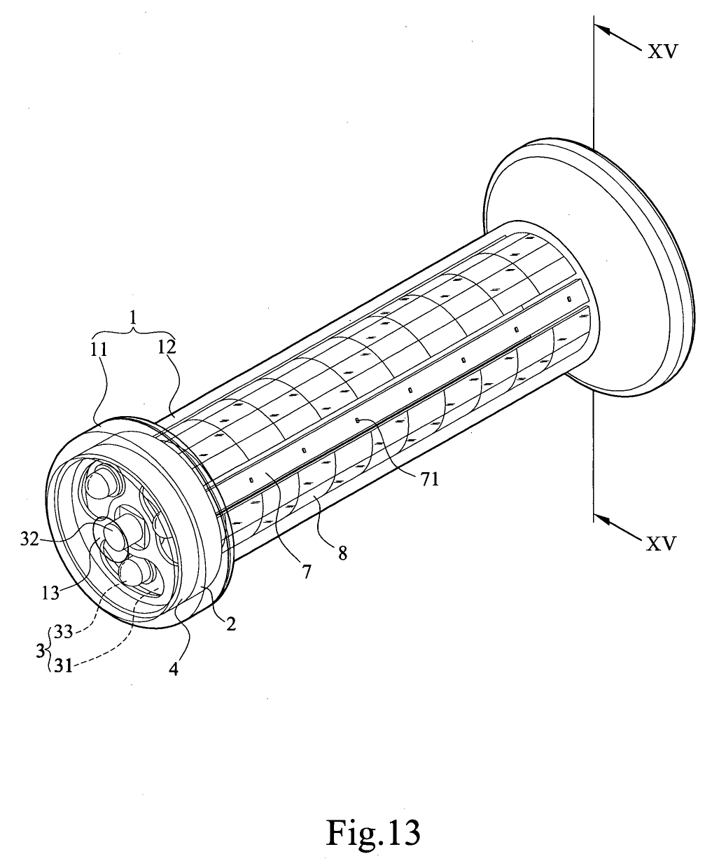

As shown in FIGS. 13,14, and 15, said grip (12) accommodates said SMDs (7) and solar panels (8) received therein. Around a perimeter circumference of the light emitting device (3) is installed with said SMDs (7) and said solar panels (8). Said solar panels (8) led into said grip (12) are disposed along said inner wall of said grip (12). Further, the solar panels (8) are electrically connected to said PCB (31) and said batteries (6) (i.e. rechargeable batteries). Said solar panels (8) can convert light into electrical energy to be preserved in the batteries (6) and to be supplied to the light emitting device (3).

### Second Embodiment

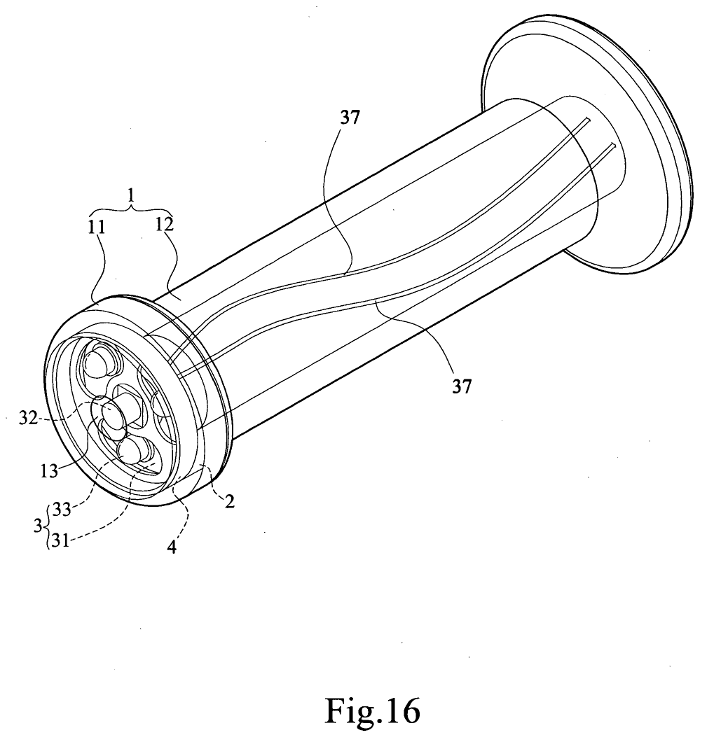

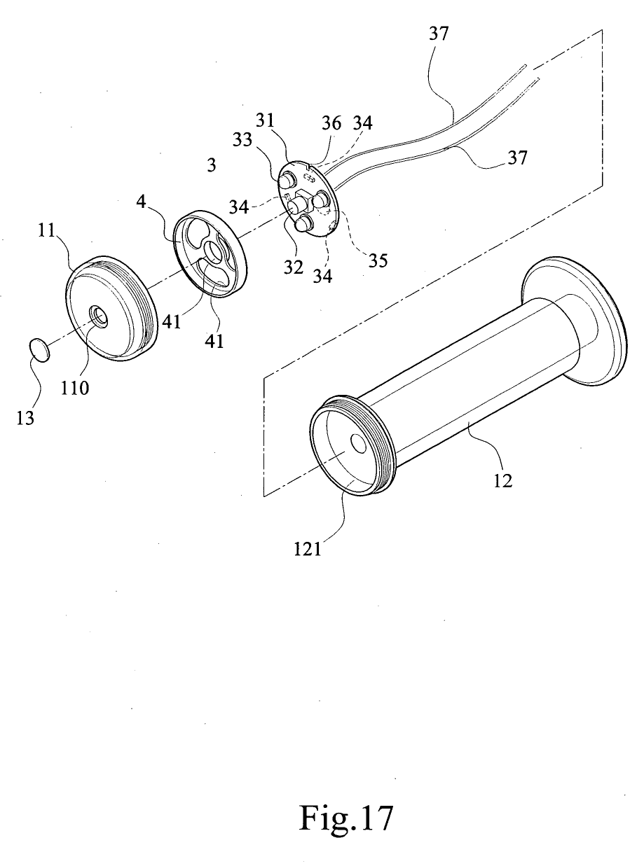

As shown in FIGS. 16 and 17, an illuminated handlebar grip (1) comprises a grip (12) pervious to light, a first open end of the grip (12) accommodates a handlebar (9) received therein, a second closed end of the grip (1) is formed with a container (121); a battery seat (2) pervious to light disposed inside the container (121); and a light emitting device (3) installed inside the container (121); the light emitting device (3) is composed of a printed circuit board (PCB) (31), a switch (32) disposed on the PCB to electrify the light emitting device, a plurality of light emitting diodes (LEDs) (33, 34) are disposed on both first and second sides of the PCB (31) relatively, and an integral circuit (IC) programmed with several effects to flash said LEDs (33, 34) in continuous sequence; said PCB (31) is connected to a power line (37) passed through the grip (12), the power line (37) is further electrically connected to a vehicle battery or an electric switch of turn light; and a cover (11) pervious to light is coupled to a second end of said grip (12); the cover (11) can cover up said container (121).

Power supply of the light emitting device (3) is provided from a vehicle battery or electric switch of turn light, when power is from the turn light, the illuminated handlebar grip (1) blinks with the turn light simultaneously as direction indicator.

The second embodiment is similar to the first embodiment, but said battery seat (2), and said batteries (6) and said spring (23) can be omitted from said second embodiment. Therefore, said vehicle battery or said electric switch of said turn light are designated as power source of said second embodiment. However, said EL (5), SMDs (7), or solar panels (8) as described in first embodiment are suitably incorporated to the second embodiment.

What is claimed is:

1. An illuminated handlebar grip (1) comprises a grip (12) pervious to light, a first open end of the grip (12) accommodates a handlebar (9) received therein, a second closed end of the grip (1) is formed with a container (121);
a battery seat (2) pervious to light disposed inside the container (121), a second end of said battery seat (2) is extended inside the grip (12) to form a cylindrical battery chamber (21) for receiving batteries (6); an outside diameter of said battery chamber (21) is smaller than an inside diameter of said handlebar (9);
and light emitting device (3) installed inside the battery seat (2), said batteries (6) supply power to the light emitting device (3), which is composed of a printed circuit board (PCB) (31), a switch (32) disposed on the PCB to activate the light emitting device, a plurality of light emitting diodes (LEDs) (33, 34) are disposed on both first and second sides of the PCB (31) relatively, and an integral circuit (IC) programmed with several effects to flash said LEDs (33, 34) in continuous sequence;
and a cover (11) pervious to light is coupled to a second end of said grip (12);
the cover (11) can cover up said container (121).

2. The illuminated handgrip (1) of claim 1 wherein a positioning cover (4) disposed inside the container (121) covers up said light emitting device (3) to resist against said cover (11); said light emitting device (3) is therefore prevented from displacements by the positioning cover (4); a plurality of holes (41) formed through the positioning cover (4) accommodates a switch (32) and a plurality of LEDs (33) passed therethrough.

3. The illuminated handgrip (1) of claim 2 wherein said cover (11) has a position hole (110) relative to the switch (32), a flexible water tight plastic cap (13) disposed inside said position hole (110).

4. The illuminated handgrip (1) of claim 1 wherein surface mounted diodes (SMDs) (7) are installed along a perimeter circumference of the light emitting device (3), said SMDs (7) are coaxially led into the grip (12); second ends of the SMDs (7) are electrically connected to PCB (31); and a plurality of LEDs (71) are disposed on the SMD (7).

5. The illuminated handgrip of claim 1 wherein solar panels (8) are installed along a perimeter circumference of the light emitting device (3), said solar panels (8) are disposed along the inner wall of the grip (12), electrically connected to both PCB (31) and rechargeable batteries (6).

6. The illuminated handlebar grip (1) of claim 1 wherein an electro luminescence (EL) (5) is installed in the grip (12); said EL is disposed along the inner wall of the grip (12); said EL can be replaced by such as fluorescent film, luminous film or light guide film.

7. The illuminated handlebar grip of claim 1 wherein a battery contact leaf spring (23) disposed in a bottom of the cylindrical battery chamber (21) in contact with said batteries (6); a spring wire (231) is extended from the spring (23) to the battery seat (2), a second end of the cord is bent, forming a hook (232) electrically connected to said PCB (31); said hook (232) is inlaid into a positioning groove (22) of the battery seat (2).

8. An illuminated handlebar grip (1) comprises a grip (12) pervious to light, a first open end of the grip (12) accommodates a handlebar (9) received therein, a second closed end of the handlebar grip (1) is formed with a container (121);
and a light emitting device (3) installed inside the container (121); the light emitting device (3) is composed of a printed circuit board (PCB) (31), a switch (32) disposed on the PCB to activate the light emitting device, a plurality of light emitting diodes (LEDs) (33, 34) are disposed on both first and second sides of the PCB (31) relatively, and an integral circuit (IC) programmed with several effects to flash said LEDs (33, 34) in continuous sequence; said PCB (31) is connected to a power line (37) passed through the grip (12), the power line (37) is further electrically connected to a vehicle battery or an electric switch of turn light;
and a cover (11) pervious to light is coupled to a second end of said grip (12); the cover (11) can cover up said container (121).

9. The illuminated handlebar grip (1) of claim 8 wherein a positioning cover (4) disposed inside the container (121) covers up said light emitting device (3) to resist against said cover (11); the light emitting device (3) is therefore prevented from displacements by the positioning cover (4); a plurality of holes (41) formed through the positioning cover (4) accommodates a switch (32) and a plurality of LEDs (33) passed therethrough.

10. The illuminated handlebar grip (1) of claim 9 wherein said cover (11) includes a position hole (110) to secure the switch (32), a flexible water tight plastic cap (13) electrically connected to the switch (32) is inlaid in said position hole (110).

11. The illuminated handlebar grip (1) of claim 8 wherein insulated SMDs (7) are installed along a perimeter circumference of the light emitting device (3), said SMDs (7) are coaxially led into the grip (12), second ends of the SMDs (7) are electrically connected to the PCB (31) and a plurality of LEDs (71) are disposed on the SMD (7).

12. The illuminated handlebar grip of claim 8 wherein solar panels (8) are installed along a perimeter circumference of the light emitting device (3); said solar panels (8) are disposed along the inner wall of the handgrip body (12) and electrically connected to both said PCB (31) and said rechargeable batteries (6).

13. The illuminated handlebar grip of claim 8 wherein an EL (5) is installed in the handgrip body (12); said EL is disposed along the inner wall of the grip (12); said EL can be replaced by fluorescent film, luminous film or light guide film.
